(19) United States
(12) Patent Application Publication
(10) Pub. No.: US 2020/0154236 A1
(43) Pub. Date: May 14, 2020

(54) AUTOMATIC TRIGGERING OF REMOTE SENSOR RECORDINGS

(71) Applicant: Google LLC, Mountain View, CA (US)

(72) Inventors: Victor Carbune, Wintherthur (CH); Sandro Feuz, Zurich (CH)

(21) Appl. No.: 16/618,213

(22) PCT Filed: Oct. 30, 2018
(86) PCT No.: PCT/US2018/058305

§ 371 Date: Nov. 29, 2019

Related U.S. Application Data
(60) Provisional application No. 62/609,913, filed on Dec. 22, 2017.

(51) Int. Cl. H04W 4/02; H04W 4/029; H04W 4/80; G06K 9/62; G11B 20/10; G06N 20/00; H04W 4/38

(52) U.S. Cl. CPC H04W 4/023; H04W 4/027; H04W 4/029; H04W 4/38; G06K 9/6221; G11B 20/10527; G06N 20/00; H04W 4/80

(57) ABSTRACT

A method includes receiving an indication that a recording event has been initiated on an initial computing device responsive to an input from a user, the initial computing device including an initial sensor recording first sensor data during the recording event. The method also includes, responsive to the indication of the initiation of the recording event, identifying, based on a respective proximity to the initial computing device of each computing device from a plurality of other computing devices associated with the user, one or more additional computing devices from the plurality of other computing devices, each computing device including at least one respective sensor device, and transmitting, to the one or more additional computing devices, an activation command that causes the one or more additional computing devices to activate the at least one respective sensor device which initiates capturing of second sensor data during the recording event.

### BACKGROUND

Many modern user computing devices may provide users with the ability to capture audio or video during various activities. For example, smartphones may include integrated digital camera devices or microphones that allow their users to capture digital recordings when desired. Further, action cameras allow users to capture video as the user participates in a physical activity such as snow skiing or surfing. The user will often manually initiate a recording session by, for example, triggering a recording by pushing a button on the device, or by activating an application to begin data capture. Once triggered, the device captures sensor data for the duration of the recording session, normally until manually terminated by the user.

### SUMMARY

The disclosed subject matter relates to techniques for automatically triggering sensor recordings from secondary user devices when the user activates a recording session on a primary user device. A user may initiate a recording session on one of the user's personal computing devices, such as a smartphone or action camera, referred to herein as the “initial computing device” or “initial sensor device.” During such recording sessions, the user may also have access to other computing devices nearby. Such other computing devices, referred to herein as “secondary computing devices” or “secondary sensor devices,” may also include sensors capable of capturing certain sensor data, such as audio, video, location information, biometric information, and so forth. When the user initiates a recording session on the initial sensor device, a coordination system detects the initiation of the recording session and activates sensor recordings on one or more of the secondary sensor devices. The coordination system determines which secondary sensor devices are available to the user at the time of the recording session based on, for example, one or more of proximity to the location of the recording session, proximity to the primary sensor device, or a user selection of one or more registered devices. The secondary devices may include sensors such as audio sensors for recording audio at the recording location, location determination sensors for determining location information of the user during the recording session, or biometric sensors for determining various biometric readings of the user during the recording session. The coordination system may build a machine learning model trained on past contextual signals of users initiating recording sessions at certain times, and using certain types of devices or sensors. The model may then be used to automatically determine which device(s) the user may be most interested in activating for a particular recording session and based on particular contextual signals associated with the particular recording session.

In one example, the disclosure is directed to a method that includes receiving, by a computing system, an indication that a recording event has been initiated on an initial computing device responsive to an input from a user. The initial computing device includes an initial sensor recording first sensor data during the recording event. The method also includes, responsive to the indication of the initiation of the recording event, identifying, by the computing system and based on a respective proximity to the initial computing device of each computing device from a plurality of other computing devices associated with the user, one or more additional computing devices from the plurality of other computing devices. Each computing device from the one or more additional computing devices includes at least one respective sensor device. The method further includes transmitting, by the computing system and to the one or more additional computing devices, an activation command that causes the one or more additional computing devices to activate the at least one respective sensor device which initiates capturing of second sensor data during the recording event.

In another example, the disclosure is directed to a computing device that includes a network adapter configured to communicatively couple the computing system with at least one additional computing device, and at least one processor. The at least one processor is configured to receive, using the network adapter, an indication that a recording event has been initiated on an initial computing device responsive to an input from a user. The initial computing device includes an initial sensor that records first sensor data during the recording event. The processor is also configured to, responsive to the indication of the initiation of the recording event, identify, based on a respective proximity to the initial computing device of each computing device from a plurality of other computing devices associated with the user, one or more additional computing devices from the plurality of other computing devices. Each computing device from the one or more additional computing devices includes at least one respective sensor device. The processor is further configured to transmit, using the network adapter and to the one or more additional computing devices, an activation command that causes the one or more additional computing devices to activate the at least one respective sensor device which initiates the capturing of second sensor data during the recording event.

In another example, the disclosure is directed to a computer-readable storage medium comprising instructions that, when executed cause at least one processor to receive an indication that a recording event has been initiated on an initial computing device responsive to an input from a user. The initial computing device includes an initial sensor that records first sensor data during the recording event. The instructions also cause the processor to, responsive to the indication of the initiation of the recording event, identify one or more additional computing devices from a plurality of computing devices based on proximity to the initial computing device. Each of the one or more additional computing devices includes at least one respective sensor device. The instructions further cause the processor to transmit, to the one or more additional computing devices, an activation command that causes the one or more additional computing devices to activate the at least one respective sensor device which initiates the capturing of second sensor data during the recording event.

The details of one or more examples are set forth in the accompanying drawings and the description below. Other features, objects, and advantages of the disclosure will be apparent from the description and drawings, and from the claims.

### BRIEF DESCRIPTION OF DRAWINGS

FIG. 1 is a conceptual diagram illustrating an example activation system for automatically triggering remote sensor recordings, in accordance with one or more aspects of the present disclosure.

FIG. 2 is a block diagram illustrating an example computing device that is configured to automatically trigger sensor recordings in the activation system shown in FIG. 1, in accordance with one or more aspects of the present disclosure.

FIGS. 3A and 3B are a flowchart illustrating example operations for automatically triggering sensor recordings in the activation system shown in FIG. 1, in accordance with one or more aspects of the present disclosure.

### DETAILED DESCRIPTION

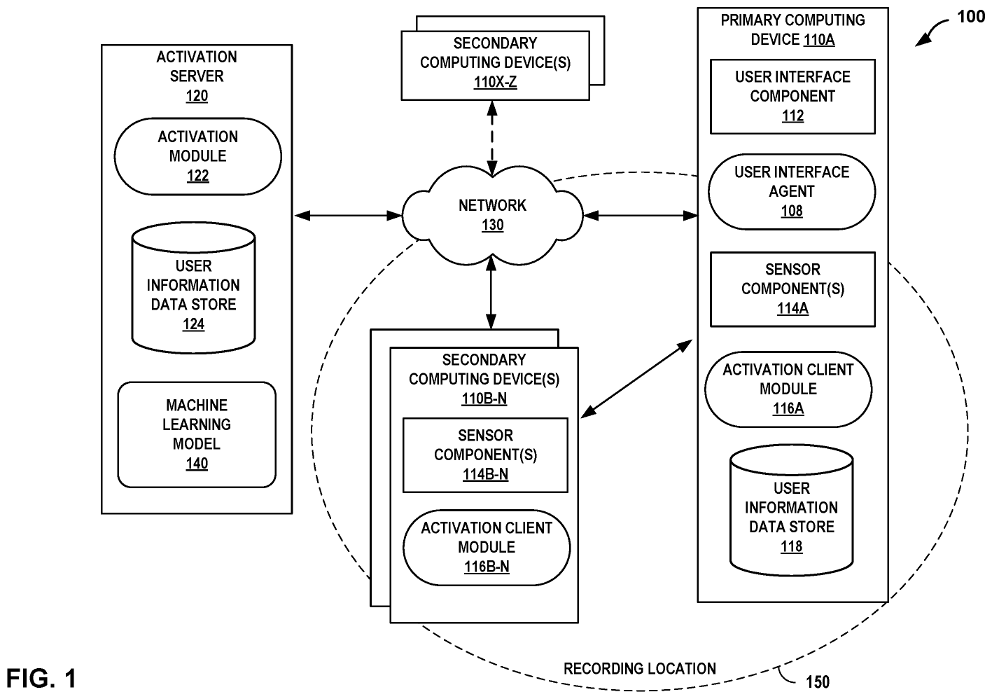

FIG. 1 is a conceptual diagram illustrating an example activation system 100 for automatically triggering remote sensor recordings, in accordance with one or more aspects of the present disclosure. System 100 of FIG. 1 includes activation server 120 in communication, via network 130, with a primary computing device 110A and secondary computing devices 110B-N (collectively, “computing devices 110”), and optionally secondary computing devices 110X-Z. Although system 100 is shown as being distributed amongst activation server 120 and computing devices 110, in other examples, the features and techniques attributed to system 100 may be performed internally, by local components of computing devices 110. For example, primary computing device 110A may include any combination of activation module 122, user information data store 124, and machine learning model 140.

In the example, network 130 represents any public or private communications network, for instance, cellular, Wi-Fi®, and/or other types of networks, for transmitting data between computing systems, servers, and computing devices. Activation server 120 may exchange data, via network 130, with computing devices 110 to provide sensor activation services for computing devices 110 when computing devices 110 are connected to network 130.

Network 130 may include one or more network hubs, network switches, network routers, wireless transmitters, or any other network equipment, that are operatively inter-coupled thereby providing for the exchange of information between activation server 120 and computing devices 110. Computing devices 110 and activation server 120 may transmit and receive data across network 130 using any suitable communication techniques. Computing devices 110 and activation server 120 may each be operatively coupled to network 130 using respective network links. The links coupling computing devices 110 and activation server 120 to network 130 may be Ethernet or other types of network connections and such connections may be wireless and/or wired connections. One or more of computing devices 110 may act as a personal wireless hotspot, thereby acting as a local portion of network 130 for the computing devices 110. Some secondary computing devices 110B-N may communicate directly with primary computing device 110A via wireless personal area networks such as Bluetooth®. Some secondary computing devices 110X-Z may not be connected with network 130 during certain periods of operation. In some examples, secondary computing devices 110X-Z represent computing devices of the user that are not near a recording location 150 and, as such, are excluded as candidates for participation in recording sessions initiated at recording location 150.

Activation server 120 represents any type of computing device that is configured to identify available computing devices 110A-N and automatically trigger remote sensor recordings on one or more those devices 110A-N. Examples of activation server 120 include cloud computing environments, desktop computers, laptop computers, servers, mobile phones, tablet computers, wearable computing devices, countertop computing devices, home automation computing devices, televisions, stereos, automobiles, or any other type of mobile or non-mobile computing device that is configured to execute an activation service.

Computing devices 110 represent individual mobile or non-mobile computing devices that are associated with a particular user or user profile, and are configured to access the virtual assistant service provided via network 130. In some instances, by being associated with a particular user, one or more of computing devices 110 may be connected to a particular network that is associated with or frequently accessed by the particular user. For instance, a subset of computing devices 110 may be located in a user's home and may communicate via a home network. Some computing devices 110 may represent individual mobile or non-mobile computing devices that are associated with other users or other user profiles (e.g., trusted users of the particular user associated with primary computing device 110A) and may be configured to participate in the systems and methods described herein via network 130.

Examples of computing devices 110 include a mobile phone, a tablet computer, a laptop computer, a desktop computer, a server, a mainframe, a set-top box, a television, a wearable device (e.g., a computerized watch, computerized eyewear, computerized gloves, etc.), a home automation device or system (e.g., an intelligent thermostat or security system), a home appliance (e.g., a coffee maker, refrigerator, etc.), a voice-interface or countertop home assistant device, a personal digital assistants (PDA), a gaming system, a media player, an e-book reader, a mobile television platform, an automobile navigation or infotainment system, an action camera device, a head-mounted display (HMD) device, or any other type of mobile, non-mobile, wearable, and non-wearable computing device. Other examples of computing devices 110 may exist beyond those listed above. Computing devices 110 may be any device, component, or processor, configured to provide sensor data via network 130.

In the example of FIG. 1, activation server 120 includes activation module 122, user information data store 124, and machine learning model 140. Primary computing device 110A includes user interface component (UIC) 112, sensor component 114A, activation client module 116A, and user information data store 118. Computing devices 110B-110N may include similar components and/or modules as computing device 110A, such as, for example, sensor components 114B-N and activation client modules 116B-N. Further, computing devices 110 may include multiple sensor components 114 or sensor components 114 of different types. Sensor components 114 are configured to capture various types of sensor data such as, for example, audio data, video data, geolocation data, biometric data (e.g., heart rate, blood pressure, etc.), and various action sports-related data (e.g., diving depth and air reserves, skydiving speed and height, running distance traveled and steps, auto speed, etc.).

User Interface Agent (UIA) 108 and modules 116, 122 may perform operations described using software, hardware, firmware, or a mixture of hardware, software, and firmware residing in and/or executing at one of computing devices 110 or activation server 120. For example, activation client module 116A may operate as an app installed on the user's smartphone, and activation client module 116B may operate as an integrated software component integrated within the user's action camera. Computing devices 110 and activation server 120 may execute UIA 108 and modules 116, 122 with multiple processors or multiple devices. Computing devices 110 and activation server 120 may execute UIA 108 and modules 116, 122 as virtual machines executing on underlying hardware. UIA 108 and modules 116, 122 may execute as one or more services of an operating system or computing platform. UIA 108 and modules 116, 122 may execute as one or more executable programs at an application layer of an operating system or computing platform.

UIC 112 of computing devices 110 may function as an input and/or output device for computing devices 110. UIC 112 may be implemented using various technologies. For instance, UIC 112 may function as an input device using presence-sensitive input screens, microphone technologies, infrared sensor technologies, cameras, or other input device technology for use in receiving user input. UIC 112 may function as output device configured to present output to a user using any one or more display devices, speaker technologies, haptic feedback technologies, or other output device technology for use in outputting information to a user. UIA 108 is a software module (e.g., app) that controls the output to and input from UIC 112, allowing the user to interact with various aspects of system 100 as described herein. For example, UIA 108 may allow the user to execute data capture software, such as a camera app, on the user's smartphone, and may also allow activation module 122 to present device or sensor activation options to the user via the touchscreen of the user's smartphone, allowing the user to select from those options.

Modules 116 may initiate user interactions via UIA 108 and UIC 112 and other components of computing devices 110 and may interact with activation server 120 so as to provide recording sessions control and functionality via UIC 112. For example, modules 116 may cause UIC 112 to prompt a user of computing devices 110 to approve activation of a sensor recording on that device 110 via a display interface provided by UIC 112 (e.g., the touchscreen of the user's smartphone). Module 116A may send instructions to UIC 112 that cause UIC 112 to display the user interface at a display screen of UIC 112.

UIC 112 may receive one or more indications of input (e.g., voice input, touch input, non-touch or presence-sensitive input, video input, audio input, etc.) from a user as the user interacts with a user interface at different times, and when the user and computing devices 110 is at different locations. UIC 112 may interpret inputs detected at UIC 112 and may relay information about the inputs detected at UIC 112 to activation client module 116, activation module 122, or one or more other associated platforms, operating systems, applications, and/or services executing at computing devices 110, for example, to cause computing devices 110 to perform actions related to triggering sensor recordings on the user's smartphone or other secondary computing devices 110B-N such as the user's action camera.

Modules 116 may receive information and instructions from one or more associated platforms, operating systems, applications, and/or services executing at computing devices 110 and/or one or more remote computing systems, such as activation server 120. In addition, modules 116 may act as an intermediary between the one or more associated platforms, operating systems, applications, and/or services executing at computing devices 110, and various output devices of computing devices 110 (e.g., speakers, LED indicators, audio or haptic output device, etc.) to produce output (e.g., a graphic, a flash of light, a sound, a haptic response, etc.) with computing devices 110 via UIC 112. For example, module 116A may cause UIC 112 to output user interfaces based on data module 116A receives via network 130 from activation server 120. UIC may receive, as input from activation server 120, activation module 122, or other modules 116, information (e.g., audio data, text data, image data, etc.) and instructions for presenting user interfaces.

Activation module 122 and activation client modules 116 may collaboratively maintain user information data stores 118, 124 as part of a recording sessions service accessed via computing devices 110. For example, activation module 122 may transmit user profile information from user information data store 124 to the user's smartphone (e.g., primary computing device 110A) for storage in user information data store 118, or activation client module 116A may transmit settings changes performed by the user on their smartphone to user information data store 124 on activation server 120. Activation module 122 and user information data store 124 represent server-side or cloud implementations of an example recording sessions service whereas activation client modules 116 and user information data store 118 represent a client-side or local implementation of the example recording sessions service. In some examples, some or all the functionality attributed to activation module 122 may be performed by activation client modules 116, and vice versa. For example, activation client module 116A may evaluate which secondary computing devices 110B-N are available for use during a particular recording session, or may determine on which secondary computing devices 110B-N to automatically initiate sensor recordings.

Activation module 122 and activation client modules 116 may each include software agents configured to record sensor data, activating and deactivating various sensor components 114 on behalf of an individual, such as a user of computing devices 110. For example, primary computing device 110A may be a smartphone of the user, and may include, as sensor components 114A, an integrated digital camera device for capturing digital video data, a microphone for capturing audio data, and a global positioning system (GPS) receiver for capturing geolocation data. The user may also possess one or more secondary computing devices 110B-N, such as a smartwatch, a tablet device, an action camera, a scuba diving computer, a personal drone, a sky diving computer, other wearable devices, and so forth. Each of such devices may include various sensors such as, for example, digital camera devices, microphones, biometric sensors for capturing various biometric readings of the user, sensors for capturing various aspects of sports or other user activities, and so forth. Any of computing devices 110 may include any variety of sensor components 114.

Activation client modules 116 capture sensor data from sensor components 114 and may perform various operations on sensor components 114 or the sensor data received from such sensor components 114. Activation client modules 116 may be configured to activate and deactivate the various sensor components 114. Further, activation module 122 may communicate with activation client modules 116 to activate or deactivate sensor components 114. Activation client modules 116, 122 may share sensor data captured during various recording sessions. For example, the user's action camera (e.g., activation client module 116B of secondary computing device 110B) may transmit digital video captured during a road trip recording session to the user's smartphone (e.g., activation client module 116A of primary computing device 110A).

For purposes of illustration, a user may have a smartphone and an action camera in the user's possession during a vacation as they travel across country by car. The user may, for example, have the action camera mounted on top of the car to capture digital video of the road and landscape in front of the car, while the user may operate their smartphone from within the car (e.g., while riding as a passenger). The user may utilize system 100 to manage aspects of a recording session as the user captures sensor data during their road trip (e.g., capturing video via the action camera, among other things). In this example, the user's smartphone may operate as primary computing device 110A, and the user's action camera may operate as one of secondary computing devices 110B-N (e.g., secondary computing device 110B). As such, the user's smartphone may include sensor components 114A such as a GPS receiver that tracks the user's location during the road trip, a microphone that may capture audio from within an interior of the car (e.g., passengers talking, music playing, ambient sounds, etc.), and an integrated digital camera (e.g., to capture hand-held video from the interior of the car as the user points the smartphone's camera at scenes of interest), and the user's action camera may include sensor components 114B such as a digital video camera and a microphone.

In order to enable activation system 100 to utilize computing devices 110, the user may register computing devices 110 with activation system 100 and may authorize or otherwise enable various automatic activation functionality of sensor components 114 described herein. Computing devices 110 of the user registered with activation system 100 may be stored in user information data store 118, 124, and may form a pool of registered devices with which system 100 may interact during operation. For example, the user may register the smartphone and the action camera with system 100 prior to the road trip vacation, thereby causing system 100 to communicate with computing devices 110A, 110B and their associated activation client modules 116A, 116B.

Throughout the disclosure, examples are described wherein system 100 may analyze information (e.g., sensor data, device location, device usage, and the like) associated with computing devices 110 of the user only if computing devices 110 or activation server 120 receives explicit permission from the user of computing devices 110 to capture or analyze the collected data. For example, in situations discussed herein in which computing devices 110 or activation server 120 may collect or may make use of sensor data captured from computing devices 110 of the user, the user may be provided with an opportunity to provide input to control whether programs or features of computing device 110 can collect and make use of user data (e.g., which devices can participate in system 100, what types of sensor data can be captured via computing devices 110 of the user, a user's preferences, a user's past and current location, etc.), or to dictate whether or how computing devices 110 or activation server 120 may receive content that may be relevant to the user. In addition, certain data may be treated in one or more ways before it is stored or used by the computing device and/or computing system, so that personally-identifiable information is removed. For example, a user's identity may be treated so that no personally identifiable information can be determined about the user, or a user's geographic location may be generalized where location information is obtained (such as to a city, ZIP code, or state level), so that a particular location of a user cannot be determined. Thus, the user may have control over how information is collected about the user and used by system 100.

During operation, the user may initiate a recording session (e.g., manually) on one of computing devices 110, such as primary computing device 110A, at recording location 150. For example, during the road trip vacation, the user may initiate a video recording on the smartphone (e.g., primary computing device 110A), causing sensor components 114A of primary computing device 110A (e.g., an integrated digital camera device and microphone) to begin capturing digital video and audio. During this recording session, the integrated camera device of the smartphone captures the initial sensor data associated with the recording (e.g., the sensor data collection initially and expressly initiated by the user). The initial sensor data, in this example, includes digital video and audio from the smartphone initiated expressly by the user via a camera app of the smartphone. Responsive to initiation of this example recording session, activation client module 116A detects that the recording session has been initiated on primary computing device 110A and, responsive to that detection, transmits a recording session initiation event to activation module 122 indicating an activation of sensor component 114A, and the beginning of a recording session. In this example, the initial sensor data for the recording session is initiated on primary computing device 110A, thereby making primary computing device 110A the initial computing device of the recording session. In other examples, the initial computing device may be one of secondary computing device 110B-N. For example, the user may have initiated a recording session by activating the action camera (e.g., secondary computing device 110B) via an action camera app on the user's smartphone, thereby making secondary computing device 110B the initial computing device for the recording session. In some examples, the recording session may be automatically initiated on primary computing device 110A. For example, a sensor activation system (not shown) may automatically initiate a recording session for a camera device (e.g., based on context features configured by the user), and activation module 122 may receive a recording session initiation event based on that automatic recording session initiation.

Responsive to receipt of the initiation event, activation module 122 identifies one or more additional computing devices (e.g., secondary computing devices 110B-N) as candidate devices for activation during the present recording session. For example, activation module 122 may identify secondary computing device 110B (e.g., the action camera) as a candidate for activation. Some secondary computing devices 110B-N, 110X-Z may be included or excluded as candidate devices based on the proximity of each of secondary computing devices 110B-N, 110X-Z to recording location 150. Proximity to recording location may be based on respective location information for each of secondary computing devices 110B-N, 110X-Z and/or wireless connectivity to computing device 110A, as non-limiting examples.

Location information (e.g., GPS location, mobile phone tracking, IP address location) for computing devices 110 may be collected and compared to the location of the initial computing device or primary computing device 110A (e.g., within a predetermined distance). For example, activation module 122 may collect a GPS location from primary computing devices 110A and secondary computing devices 110B-N, 100X-Z. For each computing device that is able to successfully return their GPS location, activation module 122 may compute a distance between primary computing device 110A (e.g., as the initial computing device) and each of the other responding computing devices to determine a relative distance between primary computing device 110A and the other computing devices. For each other computing device that is within a pre-determined distance of primary computing device 110A, activation module 122 may consider those devices as within recording location 150.

Activation module 122 may determine whether one or more of secondary computing devices 110B-N, 110X-Z are proximate to recording location 150 based on which devices are discoverable or otherwise reachable by primary computing device 110A via wireless connectivity, such as Bluetooth® or Wi-Fi®. For example, activation module 122 may communicate with activation client module 116A to determine, from the perspective of primary computing device 110A, which other computing devices are in Wi-Fi® or Bluetooth® communication network range of primary computing device 110A. In various instances, one of secondary computing devices 110B-N, 110X-Z may be considered to be within Wi-Fi® range of primary computing device 110A if the device is on a same Wi-Fi® network as primary computing device 110A. For each other computing device that is within such wireless network range, activation module 122 may consider those devices as within recording location 150. In some examples, activation client module 116A may communicate these results to activation module 122 of activation server 120.

In the example shown in FIG. 1, secondary computing devices 110B-N are proximate recording location 150 and secondary computing devices 110X-Z are not. More specifically, the action camera (e.g., secondary computing device 110B) may be determined to be within recording location 150 based on Bluetooth® or Wi-Fi® connectivity to the smartphone (e.g., primary computing device 110A). Activation module 122 may, for example, collect location information from each of the user's registered computing devices 110As such, secondary computing devices 110B-N may be included within the pool of candidate devices for activation during this example recording session, while secondary computing devices 110X-Z are not.

In some examples, activation module 122 may prompt the user with an option to activate the candidate devices. For example, activation module 122 may transmit a list of candidate devices to primary computing device 110A, where activation client module 116A may prompt the user as to which candidate devices the user wishes to activate for the ongoing recording session. Activation client module 116A may provide, for example, overlay buttons via UIC 112 as the user views the recording being made via the integrated camera, where each overlay button represents a candidate device. As such, the user may select which candidate devices to activate by touching on the associated overlay button for the particular candidate device. For example, the user may be presented with the option to activate the action camera (e.g., secondary computing device 110B) during the example recording session based on detected proximity between the action camera and the initial computing device (e.g., primary computing device 110A). Responsive to receiving selection of one or more secondary devices 110, activation client module 116A may transmit an activation selection to activation module 122 indicating the selected devices. In response, activation module 122 may subsequently transmit sensor activation commands to the selected devices (e.g., secondary computing device 110B) via their associated activation client modules (e.g., activation client module 116B) to activate the associated sensor components (e.g., sensor component 114B).

In some examples, activation module 122 may automatically determine which candidate devices to activate. For example, activation module 122 may utilize machine learning model 140 to generate device scores for each registered computing device 110. Such scores may be used by activation module 122 to automatically determine which candidate device(s) to activate during a given recording session. For example, activation module 122 may identify computing devices 110 of the user that generate a score above a pre-determined threshold. Responsive to initiation of a recording session on primary computing device 110A, activation client module 116A may transmit various recording session context elements to activation module 122 along with the activation event. Such recording session context elements may be used as inputs to machine learning model 140 to generate scores for the various devices 110. Responsive to automatic identification of one or more secondary devices 110, activation client module 116A may transmit sensor activation commands to the selected secondary computing device(s) 110B-N and activation client modules 116B-N to activate the associated sensor component(s) 114B-N.

Some of the user's computing devices may not be directly network-connected to activation server 120 and activation module 122. For example, the action camera (e.g., secondary computing device 110B) may not be connected to network 130, but may be paired via Bluetooth® with the smartphone (e.g., primary computing device 110A), and thus may be available as a prospective candidate device during the recording session. As such, activation commands may be transmitted to some secondary computing devices 110B-N indirectly via other computing devices of the user (e.g., via primary computing device 110A). For example, activation module 122 may transmit an activation command for secondary computing device 110B to activation client module 116A of primary computing device 110A via network 130, and activation client module 116A may relay that activation command to activation client module 116B on secondary computing device 110B via local Wi-Fi® or Bluetooth® connection. Accordingly, some secondary computing devices 110B-N may not require direct connection to network 130.

In some examples, the user's smartphone may operate as the activation server 120, executing activation module 122, as well as optionally acting as primary computing device 110A during the recording session. Typically, users often have smartphones with them as they conduct a recording session. Since the user's smartphone often has a convenient display and other user interface functionality, along with multiple types of sensor components, as well as communications interfaces that may allow the device to connect to network 130 or other nearby secondary computing devices 110B-N, the smartphone may act as the central broker for determining which candidate devices to activate or present to the user for activation.

In some examples, some secondary computing devices 110B-N may be owned by others, but may be explicitly permissioned by the owner to be used by activation system 100 on behalf of the primary user. For example, a secondary user may permission the primary user to add one or more of the secondary user's computing devices into a trusted set of computing devices of the primary user. As such, activation module 122 may include the computing devices of the secondary user as prospective candidate devices to activate during a recording session. The secondary user may additionally be prompted to allow the activation at the time of the activation command, thereby allowing the secondary user additional discretionary control.

Responsive to receipt of the activation commands, each selected computing device activates the identified sensor component to begin data capture for the recording session. During the recording session, the activated computing devices may store sensor data associated with the recording session locally. In some examples, the activated computing devices may transmit sensor data to activation server 120, which may store the sensor data centrally (e.g., in cloud storage, not shown). In some examples, the activated computing devices may transmit the sensor data to primary computing device 110A. The type of sensor data captured on the secondary devices is based on the particular sensors activated. For example, while activated, digital camera devices may capture digital video at a particular resolution and at a particular number of frames per second within the parameters of the camera, where biometric sensors may sample biometric readings of the user at a particular rate, or at a particular periodic interval, and so forth. Such sensor configuration may be provided by activation server 120, primary computing device 110A, or by local configuration settings on the activated device.

In some examples, activation system 100 may include synchronization functionality that may be used to align the sensor data from the various sensor components 114 used during the recording session. For example, the activated computing devices may introduce timestamp data (e.g., from a synchronized clock) at various points within the sensor data, which may subsequently be used in post-processing to align separate sensor data files captured on different devices. As such, activation client modules 116 on the activated devices may add such timestamp information to the captured sensor data at various points during the recording. In some examples, timestamp information may be coordinated between devices based on sending a synchronized signal between devices and optionally estimating offsets of the network to improve synchronization (e.g., transmitting a timestamp back and forth between devices to measure an offset).

Some devices may include multiple sensor components. For example, a smartwatch may include an infrared sensor to capture heart rate data of a wearer, an accelerometer to capture motion data, and a GPS sensor to capture location information. As such, during automatic activation, activation module 122 may consider the types of sensors available on the various computing devices 110 when determining candidate devices to activate. During manual activation, the user may be presented not only with the candidate devices to activate, but also with one or more types of sensors provided by that device (e.g., as sub-selections through the overlay buttons). Further, activation commands sent to the selected devices may identify which particular sensor components 114 to activate on that device 110.

The user may later terminate a recording session. For example, the user may manually terminate the camera recording on the initial computing device (e.g., the smartphone's digital camera of primary computing device 110A). As such, activation client module 116A may transmit a recording session termination event to one or more of activation module 122 or any of the computing devices activated during the recording session (e.g., the action camera's digital camera of secondary computing device 110B). Similarly, in response to receiving a termination event, activation module 122 may transmit a termination event to any of the computing devices activated during the recording session. Such a termination event may also prompt the activated computing devices to transmit the collected sensor data to activation server 120, to primary computing device 110A, to the initial computing device, or to another receiving location (e.g., to cloud storage, to a personal data storage warehouse of the user, etc.).

In some scenarios, some of the activated computing devices may automatically deactivate during the recording session based on one or more automatic deactivation conditions. Some automatic deactivation conditions may be based on sensor data from the activated sensor components. For example, during the road trip, presume the user activates the action camera mounted on the car (e.g., as the initial computing device, sensor component 114B of secondary computing device 110B), thereby starting a recording session, and activation system 100 automatically activates a microphone on the smartphone of the user (e.g., as an additional computing device, sensor component 114A of primary computing device 110A) to capture audio of conversation within the car to go along with the exterior video captured by the action camera. However, during the recording session, activation client module 116A of the additional computing device analyzes the microphone data and detects, at some point, that the conversation has lapsed and no one is speaking (e.g., decibel levels below a pre-determined threshold for a pre-determined period of time). As such, activation client module 116A may automatically deactivate the microphone, thereby stopping the recording of the audio on the additional computing device. Similarly, activation client modules 116 on other additional computing devices may deactivate other types of sensors based on determined disuse relative to the particular signal types. For example, an accelerometer may be deactivated after a predetermined period of minimal motion (e.g., indicating that the user has concluded the physical activity), or a heart rate monitor may be deactivated after a predetermined period of detecting a resting heart rate of the user or an absence of heart rate data (e.g., indicating that the device may have been removed), or a GPS receiver may be deactivated after a predetermined stationary period (e.g., indicating that the device is no longer changing location), or a video camera may be deactivated after a predetermined period of minimal change in the video, or of predominantly black input (e.g., indicating that the lens is covered).

After receiving explicit user consent, activation system 100 may track recording session data associated with the operation of activation system 100 on behalf of the user over time. Such recording session data may be subsequently used as training data to build machine learning model 140. Modules 116, 122 may allow the user to enable or disable tracking of recording session data during the course of operation. Such recording session data may include, for example, what primary computing device 110A was used in the recording session, which sensor component(s) 114A were used in the recording session, or what type of data was captured by the primary computing device 110A during the recording session. In some examples, recording session data may include context features for the owner of devices 110, such as the user's recording history, calendar events, sensor data to determine context (e.g., biometric heart rate to detect exercise in progress, blood pressure to detect stress levels, etc.). Recording session data may include activation and deactivation event data identifying, for example, which computing devices and sensors were identified as candidate devices or sensors for the recording session, which candidate devices or sensors were identified for activation during the recording session, which devices or sensors were identified but not activated, and whether the activated devices were user-initiated (e.g., manually selected) or system-initiated (e.g., automatically selected) for activation. Recording session data may also include which computing devices were later selected for deactivation during the recording session, and whether those deactivations were user-initiated or system-initiated. Recording session data may include context information associated with the recording session, such as timing information associated with the recording session (e.g., how long the devices 110 were active in the recording session, time-of-use information associated with the recording session, etc.), or location information associated with the recording session (e.g., where the recording session was conducted). Recording session data may include post-usage data associated with the data collected during the recording session, such as which secondary data was subsequently used by the user and how much of that secondary data was used by the user.

Various other example use cases are anticipated by the present disclosure. Such use cases highlight various technological benefits afforded by activation system 100 in activating additional devices that can capture data associated with a recording session. Some use cases include capturing supplemental sensor data of a different type than the primary sensor data. For example, activation of an action camera to capture digital video may be supplemented by capturing audio near the primary device or by capturing location information as the digital video on the initial device is captured (e.g., during the road trip), or by capturing biometric data of the user as the user films a sporting or exercise activity (e.g., capturing heart rate, blood pressure, calories burned, etc.), or by capturing scuba diving or skydiving data as the user films a dive. Such uses may provide data that supplements the initial sensor recordings, allowing the user to view or otherwise present additional data at the time of the recording. Some use cases include capturing supplemental sensor data of the same type as the primary sensor data. For example, the user may be recording a video with audio at a recording location, but the event may be such that some speakers are too distant from a primary microphone of the initial device to have a discussion adequately recorded, or the primary audio may periodically be garbled. As such, secondary microphones may be activated to capture additional audio from different locations near the initial device, which may provide an additional perspective for the recordings, or redundancy in the event that the primary recordings prove insufficient at certain times.

Among the several benefits provided by the aforementioned approach are: (1) reducing data loss due to corrupt sensor data by capturing additional sensor data via similar nearby sensors; (2) reducing collection of extraneous sensor data by automatically determining which devices to activate during a given recording session based on context information for that recording session and historical device usage of past recording sessions; and (3) reducing processing complexity in post-production analysis of sensor data by introducing time synchronization data into disparate streams of sensor data.

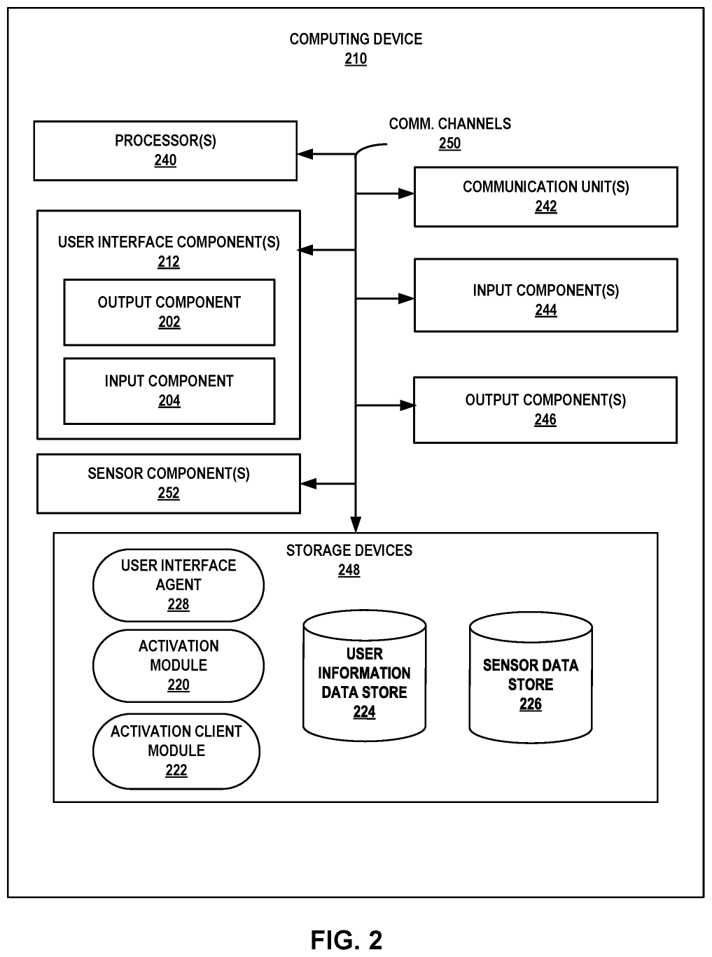

FIG. 2 is a block diagram illustrating an example computing device that is configured to automatically trigger sensor recordings in the activation system 100 shown in FIG. 1, in accordance with one or more aspects of the present disclosure. Computing device 210 of FIG. 2 is described below as an example of computing devices 110 of FIG. 1. FIG. 2 illustrates only one particular example of computing device 210, and many other examples of computing device 210 may be used in other instances and may include a subset of the components included in example computing device 210 or may include additional components not shown in FIG. 2.

As shown in the example of FIG. 2, computing device 210 includes user interface component (UIC) 212, one or more processors 240, one or more communication units 242, one or more input components 244, one or more output components 246, one or more storage components 248, and one or more sensor components 252. UIC 212 includes output component 202 and input component 204. Storage components 248 of computing device 210 include activation module 220, one or more activation client modules 222, user information data store 224, and sensor data store 226.

Communication channels 250 may interconnect each of the components 212, 240, 242, 244, 246, 248, and 252 for inter-component communications (physically, communicatively, and/or operatively). In some examples, communication channels 250 may include a system bus, a network connection, an inter-process communication data structure, or any other method for communicating data.

One or more communication units 242 of computing device 210 may communicate with external devices via one or more wired and/or wireless networks by transmitting and/or receiving network signals on the one or more networks. Examples of communication units 242 include a network interface card (e.g. such as an Ethernet card), an optical transceiver, a radio frequency transceiver, a global positioning satellite (GPS) receiver, or any other type of device that can send and/or receive information. Other examples of communication units 242 may include short wave radios, cellular data radios, wireless network radios, as well as universal serial bus (USB) controllers.

One or more input components 244 of computing device 210 may receive input. Examples of input are tactile, audio, and video input. Input components 244 of computing device 210, in one example, includes a presence-sensitive input device (e.g., a touch sensitive screen, a presence-sensitive display, etc.), mouse, keyboard, voice responsive system, video camera, microphone or any other type of device for detecting input from a human or machine. In some examples, sensor components 252 may include, for example, one or more location sensors (e.g., GPS components), one or more temperature sensors, one or more movement sensors (e.g., accelerometers, gyros, etc.), one or more pressure sensors, and one or more other sensors (e.g., an audio sensor such as a microphone, an optical image sensor, infrared proximity sensor, etc.). Other sensors may include a heart rate sensor, magnetometer, glucose sensor, hygrometer sensor, olfactory sensor, compass sensor, step counter sensor, to name a few other non-limiting examples. Sensor components 252 may be similar to sensor components 114 of FIG. 1.

One or more output components 246 of computing device 110 may generate output. Examples of output are tactile, audio, and video output. Output components 246 of computing device 210, in one example, includes a presence-sensitive display, sound card, video graphics adapter card, speaker, liquid crystal display (LCD), organic light emitting diode (OLED) display, or any other type of device for generating output to a human or machine.

UIC 212 of computing device 210 may be similar to UIC 112 of computing devices 110 and includes output component 202 and input component 204. Output component 202 may be a display component, such as a screen at which information is displayed by UIC 212 and input component 204 may be a presence-sensitive input component that detects an object at and/or near output component 202. Output component 202 and input component 204 may be a speaker and microphone pair or any other combination of one or more input and output components, such as input components 244 and output components 246. In the example of FIG. 2, UIC 212 may present a user interface.

While illustrated as an internal component of computing device 210, UIC 212 may also represent an external component that shares a data path with computing device 210 for transmitting and/or receiving input and output. For instance, in one example, UIC 212 represents a built-in component of computing device 210 located within and physically connected to the external packaging of computing device 210 (e.g., a screen on a mobile phone). In another example, UIC 212 represents an external component of computing device 210 located outside and physically separated from the packaging or housing of computing device 210 (e.g., a monitor, a projector, etc., that shares a wired and/or wireless data path with computing device 210).

One or more storage components 248 within computing device 210 may store information for processing during operation of computing device 210 (e.g., computing device 210 may store data accessed by modules 220 and 222, and data stores 224 and 226 during execution at computing device 210). In some examples, storage component 248 is a temporary memory, meaning that a primary purpose of storage component 248 is not long-term storage. Storage components 248 on computing device 210 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage components 248, in some examples, also include one or more computer-readable storage media. Storage components 248 in some examples include one or more non-transitory computer-readable storage mediums. Storage components 248 may be configured to store larger amounts of information than typically stored by volatile memory. Storage components 248 may further be configured for long-term storage of information as non-volatile memory space and retain information after power on/off cycles. Examples of non-volatile memories include magnetic hard disks, optical disks, floppy disks, flash memories, or forms of electrically programmable memories (EPROM) or electrically erasable and programmable (EEPROM) memories. Storage components 248 may store program instructions and/or information (e.g., data) associated with modules 220, 222, and 228, and data stores 224 and 226. Storage components 248 may include a memory configured to store data or other information associated with modules 220, 222, and 228 and data stores 224 and 226.

One or more processors 240 may implement functionality and/or execute instructions associated with computing device 210. Examples of processors 240 include application processors, display controllers, auxiliary processors, one or more sensor hubs, and any other hardware configure to function as a processor, a processing unit, or a processing device. Modules 220, 222, and 228 may be operable by processors 240 to perform various actions, operations, or functions of computing device 210. For example, processors 240 of computing device 210 may retrieve and execute instructions stored by storage components 248 that cause processors 240 to perform the operations modules 220, 222, and 228. The instructions, when executed by processors 240, may cause computing device 210 to store information within storage components 248, for example, at data stores 224 and 226.

UI components 212 and UIA 228 may include all functionality of UIC 112 and UIA 108 of FIG. 1 and may perform similar operations as UIC 112 and UIA 108 for executing activation module 220 and activation client module 222 as part of computing device 210. UIA 228 may manage user interactions with UIC 212 and other components of computing device 210. UIA 228 may cause UIC 212 to output a user interface as a user of computing device 210 views output and/or provides input at UIC 212.

User information data store 224 is an example of user information data stores 118 and 124 of FIG. 1. User information data store 224 may include one or more user profiles associated with respective users of computing device 210 and/or users of other computing devices (e.g., computing devices 110 of FIG. 1). In some examples, a user profile may include user information obtained with permission from the user. For example, each user profile may include device identifiers, device profiles, and sensor information associated with registered devices of the user or devices of other secondary users for which the primary user is permissioned. Each user profile may include information indicative the user's interests and/or user preferences. A user profile may include recording session data, which may indicate when the user has activated recording sessions and which devices were used in those recording sessions.

Activation module 220 may include all functionality of activation module 122 of FIG. 1 and may perform similar operations as activation module 122, generally representing, for example, an application service used to determine which computing devices and associated sensors of the user to activate during a given recording session. Activation client module(s) 222 may include all functionality of activation client modules 116 of FIG. 1 and may perform similar operations as activation client modules 116, generally representing, for example, an application service used to interface with and control sensor components 114. In some examples, activation client modules 222 may act as an interface to activation module 220.

Activation module 220 may be configured to orchestrate activation of sensor components 252 of computing device 210 or on other computing devices such as secondary computing devices 110 during a recording session, and in response to a recording session initiation event received from activation client module 222. Activation module 220 may send activation commands to other computing devices 210, such as secondary computing devices 110B-N, and may receive sensor data from those other computing devices 210. Sensor data from such recording sessions may be stored in sensor data store 226 on the computing device 210 hosting the source sensor component 252, or on another computing device 210 participating in system 100.

As one example, computing device 210 may act as primary computing device 110A during a recording session. The user may initiate a recording session by, for example, initiating a video recording using an integrated camera application on a smartphone (e.g., where the smartphone is computing device 210 and the integrated camera is one of sensor components 252). In response to the manual activation of the integrated camera, activation client module 222 transmits a recording session initiation event message to activation module 220. Activation module 220 determines candidate devices available to the user, such as based on information about registered devices associated the user stored in user information data store 224, or based on applying machine learning model 140 to context information for the recording session. For example, the user may also have an action camera and a smartwatch while on the road trip vacation, both of which may be example computing devices 210, and where the action camera includes a video camera sensor and the smartwatch includes biometric sensors providing biometric data of the user.

In some examples, for user-based selection of secondary devices, activation module 220 transmits a list of candidate devices to UIA 228. User interface agent 228 presents candidate devices to the user for optional secondary device activation confirmation. For example, UIA 228 may present overlay buttons to the user via user interface components 212 and receive selection indications of one or more candidate devices from the user. UIA 228 transmits a list of the selected device(s) to activation module 220 for activation during the recording session.

In some examples, for automatic selection of secondary devices, activation module 220 automatically determines which secondary devices to activate during the recording session. Activation module 220 may receive or otherwise identify context information associated with the recording session and apply the context information as inputs to machine learning model 140 to generate scores for each of the registered devices of the user. In some examples, Activation module 220 identifies any number of devices having scores above a predetermined threshold and automatically selects those devices for activation during the recording session.

Responsive to identification of the selected devices (e.g., either user-selected or system-selected), activation module 220 transmits activation commands to each of the selected devices. Activation commands may be transmitted to activation client module 222 on the selected device. When received, activation client module 222 of the selected device then activates the identified sensor component 252, thereby initiating recording of secondary sensor data. While active, sensor component 252 generates sensor data as a part of the recording session, and may store sensor data directly into sensor data store 226, or may transmit sensor data to activation client module 222 for subsequent use. Activation client module 222 may additionally add synchronization information to the sensor data to facilitate post-production synchronization with other sensor data captured as a part of the recording session. The recording session and associated sensor data may be tracked with a unique identifier to facilitate identifying which recording session a given sensor data set is associated. Activation client module 222 may transmit sensor data to activation module 220 or to other computing devices associated with the recording session (e.g., primary computing device 110A).

Activation module 220 may transmit deactivation commands to activated devices. For example, activation module 220 may receive a session termination event from activation client module 222 of primary computing device 110A, on which the recording session was initiated (e.g., when the user terminates the video recording on a smartphone). Responsive to receiving the session termination event, activation module 220 may then transmit sensor deactivation commands to each of the activated sensor devices (e.g., via each of their respective activation client modules 222). As such, each activation client module 222 deactivates the identified sensor, thereby terminating capture of sensor data for that sensor component 252. In some scenarios, activation client module 222 may be configured to automatically deactivate the activated sensor component 252 (e.g., based on analysis of sensor data, without having received a deactivation command).

Activation module 220 may additionally store details associated with the recording session, such as which devices and sensors were activated, whether the sensors were automatically or manually selected, context information associated with the recording session, and other data used to train machine learning model 140. Such recording session details may be stored and used to train machine learning model 140, thereby enabling enhanced performance of model 140 in future uses.

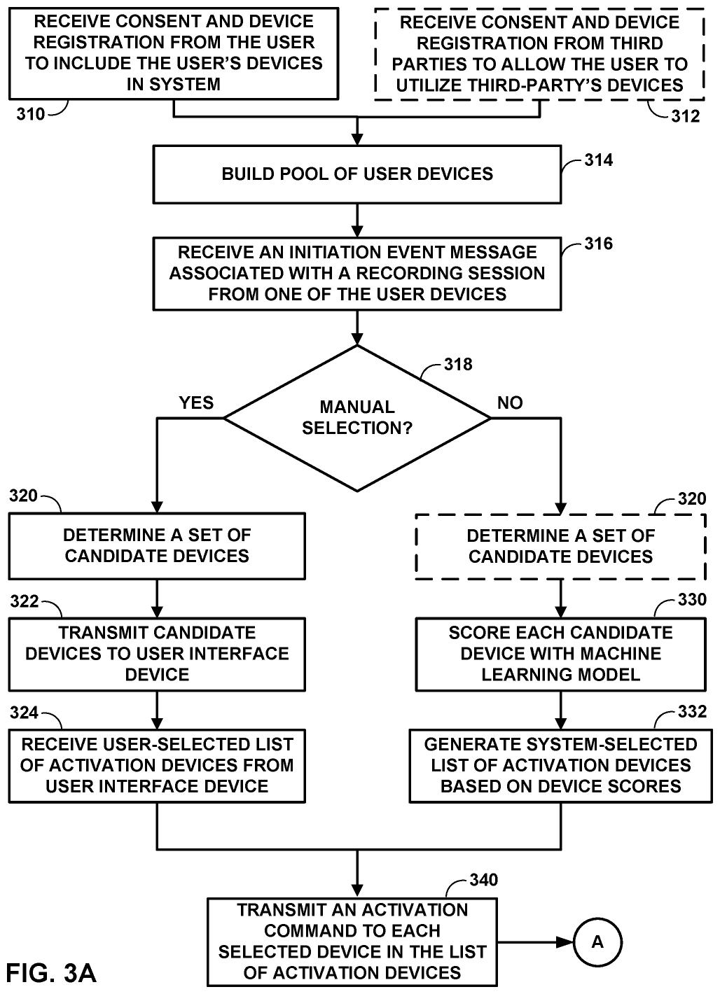

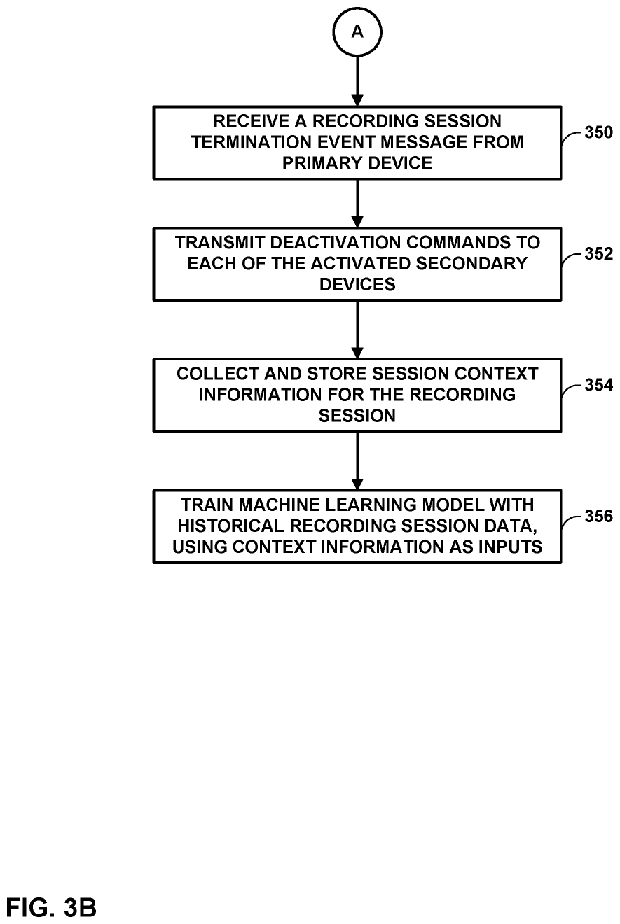

FIGS. 3A and 3B are a flowchart illustrating example operations for automatically triggering sensor recordings in the activation system 100 shown in FIG. 1, in accordance with one or more aspects of the present disclosure. FIGS. 3A and 3B are described below in the context of primary computing device 110A or activation server 120 executing activation module 122 of FIG. 1 in conjunction with various activation client modules 116 executing on computing devices 110. For example, activation module 122, while executing at one or more processors of primary computing device 110A, may perform operations 300-356, in accordance with one or more aspects of the present disclosure. In some examples, activation module 122 may be executing on activation server 120 or on any of computing devices 110. In some examples, primary computing device 110A may be the initial device for a recording session and secondary computing device 110B may be the additional device identified for the recording session, such as in the road trip example presented above.

In operation, and referring now to FIG. 3A, activation module 122 receives consent from a user to make use of one or more computing devices 110, registering those identified computing devices 110 for use with activation system 100 (310). For instance, activation module 122 may cause UTA 108 to display a device registration screen to the user, thereby allowing the user to identify, permission, and register devices 110 for use with activation system 100. It should be understood that activation server 120 may or may not require a user to consent prior to each time that activation module 122 subsequently makes use of devices 110 or stores sensor data collected by devices 110 during recording sessions. For example, if activation module 122 receives consent once a year, once a day, or even just one time (e.g., after initial product purchase, set up, etc.) activation module 122 may treat that prior consent as consent to make use of devices 110 for a recording session.

Activation module 122 may receive consent from third parties (e.g., friends, relatives, other trusted users, etc.) to allow the primary user to utilize computing devices of those third parties (312). For instance, activation module 122 associated with the primary user may communicate with a computing device of a third party to allow that third-party user to identify and permission for use one or more of that third party's devices (e.g., the third party's smartphone, action camera, etc.). Such third-party devices may be similar to computing devices 110.

Activation module 122 builds a pool of user devices (314). This pool of user devices includes the registered computing devices 110 permissioned by the primary user (e.g., primary computing device 110A and secondary computing devices 110B-N, 110B-Z), and may additionally include any third-party computing devices permissioned, by the third parties, for use by the primary user. This pool of user devices represents the devices that are within the potential scope of use of activation module 122 during a recording session. It should be understood that building the pool of user devices (314) may include identifying all of the previously-registered devices of the primary user and, as such, may constructively be complete after computing devices 110 are registered.

Activation module 122 receives an initiation event message associated with a recording session from one of the primary user's computing devices 110 (316). The initiation event message represents an indication that the user has initiated a recording session on one of computing devices 110 (e.g., primary computing device 110A as the initial device), and using one or more sensor components 114 of the computing device. For example, the user may have manually started a video recording on their smartphone during their road trip. The initiation event message may additionally include context information regarding the recording session, such as which computing device 110 is already actively collecting sensor data for the recording session (e.g., primary computing device 110A, acting as the initial device for the recording session), which sensor(s) 114 within that computing device have been activated (e.g., the digital camera device and microphone of the user's smartphone), and other information associated with the recording session (e.g., start time, current location of primary computing device 110A, recording session identifier, etc.).

In some scenarios, activation system 100 may be configured to allow the user to manually select which additional devices are activated during the recording session. For example, activation module 122 may allow the user to configure system 100 to a “manual selection mode.” If activation system 100 is configured to manual selection mode (“YES” branch of 318), then activation module 122 performs operations (320), (322), and (324). Otherwise, if activation system 100 is configured to an “automatic selection mode,” which allows activation module 122 to automatically determine which additional devices and sensor components to activate, then activation module 122 performs operations (320), (330), and (332).

More specifically, in “manual selection mode,” activation module 122 determines a set of candidate devices (320) that may be activated during the current recording session. In some examples, determining the set of candidate devices may include identifying all of the devices identified at operation (314). In some examples, determining the set of candidate devices may include eliminating some devices as candidate devices if those particular devices are not near the recording session, or are not currently powered on. For example, activation module 122 may determine location information for devices via GPS location or proximity information collected by those devices, and may include or exclude particular devices based on whether they are within a pre-determined distance of the initial device or primary computing device 110A. Activation module may include or exclude particular devices based on whether those particular devices are within wireless connectivity range of other devices. For example, a particular device may be excluded if that device cannot wirelessly be contacted by primary computing device 110A (e.g., via local Wi-Fi® connectivity or Bluetooth® connectivity, etc.). The included devices represent a subset of devices from the pool of devices, referred to herein as a set of candidate devices (e.g., devices from which the user may pick during manual selection).

In some examples, activation module 122 may remove or sort, promote, or demote devices within a list based on whether the device is currently powered on, remaining battery time on the device, current usage of the device (e.g., if currently being used by another app), an amount of storage remaining on the device, or a length of time since the device has been activated in a recording session.

Activation module 122 transmits a listing of the set of candidate devices to the user for manual device selection by the user (e.g., via UIA 108 on primary computing device 110A) (322). For example, activation module 122 may have identified the action camera as a candidate device based on determining that the action camera is network-connected to the smartphone at the time of the recording session. As such, activation module 122 may transmit the identity of the action camera as a candidate device for activation. Further, the transmitted information at operation (322) may also include device information, such as unique device identifier (e.g., to uniquely identify the action camera) and a list of available sensors available to the candidate device(s) (e.g., a digital camera, a microphone, etc.). Based on the transmitted list of candidate devices and associated device information, UIA 108 may display the candidate devices as additional device options which may be activated by the user during the recording session. UIA 108 may allow the user to select one or more devices (e.g., indicating that the user wishes to activate data collection on all of the sensors available on a particular device, or on a pre-identified subset of sensors available on that particular device), or may allow the user to select which sensor(s) to activate on the particular devices.

Activation module 122 receives a user-selected list of devices from UIA 108 (324). The user-selected list of devices may be referred to herein as “activation devices” or “additional devices,” and any particular selected sensors of those devices may be referred to herein as “activation sensors” or “additional sensors,” as they are selected or otherwise identified for activation during the recording session. For example, the user may have desired to record exterior video of their road trip to go along with the video and audio being recorded by the smartphone (e.g., thereby allowing the user to potentially use some of the exterior video of the road trip during later post-production video editing). As such, the user may have selected the digital camera from within the action camera as the option to enable for activation for the recording session.

In “automatic selection mode,” in some examples, activation module 122 may similarly determine a set of candidate devices (320), as described above. Such operation may serve to include or exclude some devices from the set of candidate devices prior to application of machine learning model 140 described below.

Further, during “automatic selection mode,” activation module 122 scores each candidate device or candidate sensor using machine learning model 140 for potential selection as an activation device or activation sensor (330). Machine learning model 140 may score at a device level or at a level of a particular sensor on a particular device. Machine learning model 140 takes various inputs on which model 140 was trained, such as, for example, which sensors are available to the particular device, where the device is currently located (e.g., absolute position, relative distance to primary computing device 110A, etc.), whether the device has connectivity (e.g., to primary computing device 110A, to activation module 122), what type of connectivity the candidate device has (e.g., direct connectivity to network 130, secondary connectivity to another device, etc.), what app(s) are being used as a part of the recording session, historical information associated with co-used devices or co-used sensors in past recording sessions, other sensor metadata, and contextual information about the recording session. Contextual information about the recording session may include, for example, what device is currently acting as the primary computing device (e.g., the device from which the current recording session was initiated), what sensor(s) are active in the recording session, and the location of the recording session. Such input information may be provided by primary computing device 110A, or from user information data stores 118, 124, 224.

Application of the inputs for each device or sensor within the device to machine learning model 140 generates a score (“confidence score”) for that device or sensor that represents a level of confidence as to whether the particular device or sensor should be activated for the present recording session. Based on the generated scores, activation module 122 generates a system-selected list of activation devices to enable during the recording session. The system-selected list may include devices having confidence scores that are above a pre-determined threshold. In some examples, the user may set or change the pre-determined threshold. In some examples, the pre-determined threshold may be automatically changed based on historical recording sessions by, for example, evaluating situations in which devices were manually activated by the user after they failed automatic activation due to scoring below the threshold, or situations in which devices were manually deactivated by the user after being automatically activation due to scoring above the threshold.

In some examples, activation module 122 may perform a hybrid system in which activation module 122 scores the candidate devices or candidate sensors and presents only those devices or sensors scoring above the pre-determined threshold to the user for manual selection. In other words, machine learning model 140 may be used to determine (e.g., at operation (320)) which devices or sensors are presented as suggested devices or sensors to the user at operation (322).

Once the list of activation devices has been identified (e.g., “manually” or “automatically”), activation module 122 transmits activation commands to each of the identified devices and sensors. More specifically, activation module 122 transmits an activation command for each identified activation sensor to the device hosting that particular sensor (340). Responsive to receipt of the activation command, the receiving activation client module activates data collection on the identified sensor, thereby beginning data collection from that sensor. In some examples, activation client modules 116 of the activated sensors may add timestamp information to the collected sensor data.

Referring now to FIG. 3B, at a later time, the user may manually terminate the recording session. For example, and continuing the above dive example, the user may stop the video recording on the handheld action camera, perhaps when they have resurfaced, or when they begin an ascent from depth. At that time, activation client module 116A of the action camera (e.g., acting as primary computing device 110A) transmits a recording session termination event message to activation module 122 (e.g., also executing on primary computing device 110A). Activation module 122 receives the termination event message (350). In response to the termination event message, activation module 122 transmits deactivation commands to each of the activated secondary devices to deactivate each of the activated sensors (e.g., via the local activation client modules) (352). Accordingly, responsive to receipt, data collection on each of the activated sensors is terminated locally on each of the activated secondary devices.

Activation module 122 may collect the captured sensor data from each of the sensors active during the recording session. For example, each of the active computing devices 110 may transmit the captured sensor data to activation server 120, or to primary computing device 110A. The sensor data may be centrally or locally stored in sensor data store 226.

Further, activation module 122 collects session context information for the recording session (354). Such session context information may subsequently be used to train or update machine learning model 140 (356), thereby enabling machine learning model 140 to better react to future recording sessions of the user by integrating historical session context information from past recording sessions of the user.

In some examples, activation module 122 trains machine learning model 140 using historical recording session data genericized and distilled from a pool of consenting users. Machine learning model 140 may be a pre-trained embedding neural network model trained on the example recording session data and context information, as described above, from historical recording sessions. As such, machine learning model 140 may be generically applied to various users of system 100. In some examples, machine learning model 140 may be built custom models 140 individually for a particular user of activation system 100. For example, machine learning model 140 may be trained with both historical training data of other users and of the particular user, but the training data of the particular user may be weighted such as to cause the model to more accurately reflect what the particular user may do in a given recording session, while still leveraging a broader body of training data to build a suitably robust model 140. In some examples, a confidence score during training may be binary (e.g., either 1 or 0 if the particular sensor or device was or was not activated in the training example, respectively). Machine learning model 140 may produce a continuous confidence score between 1.0 and 0.0, and the loss may be proportional to abs(confidence_score−ground_truth) (i.e., where the disabled “ground_truth=0” samples generate a lower confidence score and the enabled “ground_truth=1” samples would generate a higher confidence score. In some examples, activation module 122 may train machine learning model 140 as a recurrent neural network based on models that work well on sequence data (e.g., with multiple Long Short Term Memory (LSTM) or gated recurrent units (GRU) layers), optionally in conjunction with a sequence to sequence (Seq2Seq) architecture. In some examples, training data may explicitly include more weight to the “positive” samples (i.e., where a recording event is triggered), as they are more sparse. In some examples, machine learning model 140 may be trained with partially synthetic training data from real examples (e.g., using data from sequences where nothing happens, and then ‘inserting’ a portion leading up to a recording event).

In some examples, a method may include receiving, by a computing system, an indication that a recording event has been initiated on an initial computing device responsive to an input from a user, the initial computing device including an initial sensor recording first sensor data during the recording event, responsive to the indication of the initiation of the recording event, identifying, by the computing system and based on a respective proximity to the initial computing device of each computing device from a plurality of other computing devices associated with the user, one or more additional computing devices from the plurality of other computing devices, each computing device from the one or more additional computing devices including at least one respective sensor device, and transmitting, by the computing system and to the one or more additional computing devices, an activation command that causes the one or more additional computing devices to activate the at least one respective sensor device which initiates capturing of second sensor data during the recording event. The method may also include scoring, by the computing system and using a machine learning model, each computing device from the plurality of other computing devices associated with the user, and selecting, by the computing system and based on the scoring, the one or more additional computing devices. The method may also include outputting, by the computing system and for display by the initial computing device, information about the plurality of other computing devices associated with the user, and receiving, by the computing system, a selection of the one or more additional computing devices from the plurality of other computing devices. The method may also include receiving, by the computing system and from the initial computing device, an indication that the recording event has been terminated, and responsive to receiving the indication that the recording event has been terminated, transmitting, by the computing system and to the one or more additional computing devices, a deactivation command that causes the one or more additional computing devices to deactivate the at least one respective additional sensor device which terminates the capturing of the second sensor data.

The method may also include identifying a set of registered computing devices of the user, the set of registered computing devices including the initial computing device and the one or more additional computing devices, and determining, by the computing system and responsive to receiving the indication that the recording event has been initiated, whether each registered computing device of the set of registered computing devices is proximate to the initial computing device, wherein identifying one or more additional computing devices from the plurality of other computing devices is further based on the determining. The method may also include determining a location of the initial computing device, determining a location of a candidate computing device from the plurality of other computing devices associated with the user, determining, based on the location of the initial computing device and the location of the candidate computing device, whether a distance between the initial computing device and the candidate computing device satisfies a distance threshold, and responsive to determining that the distance between the initial computing device and the candidate computing device satisfies the distance threshold, identifying the candidate computing device as being one of the one or more additional computing devices. The method may also include determining that the one or more additional computing devices are communicatively coupled to the initial computing device via a wireless communications medium.

In one example, a computing system includes means for receiving, by a computing system, an indication that a recording event has been initiated on an initial computing device responsive to an input from a user, the initial computing device including an initial sensor recording first sensor data during the recording event, means for responsive to the indication of the initiation of the recording event, identifying, by the computing system and based on a respective proximity to the initial computing device of each computing device from a plurality of other computing devices associated with the user, one or more additional computing devices from the plurality of other computing devices, each computing device from the one or more additional computing devices including at least one respective sensor device, and means for transmitting, by the computing system and to the one or more additional computing devices, an activation command that causes the one or more additional computing devices to activate the at least one respective sensor device which initiates capturing of second sensor data during the recording event. In some examples, the computing system includes means for scoring, by the computing system and using a machine learning model, each computing device from the plurality of other computing devices associated with the user, means for selecting, by the computing system and based on the scoring, the one or more additional computing devices, means for outputting, by the computing system and for display by the initial computing device, information about the plurality of other computing devices associated with the user, means for receiving, by the computing system, a selection of the one or more additional computing devices from the plurality of other computing devices, means for receiving, by the computing system and from the initial computing device, an indication that the recording event has been terminated, means for responsive to receiving the indication that the recording event has been terminated, transmitting, by the computing system and to the one or more additional computing devices, a deactivation command that causes the one or more additional computing devices to deactivate the at least one respective additional sensor device which terminates the capturing of the second sensor data, means for identifying a set of registered computing devices of the user, the set of registered computing devices including the initial computing device and the one or more additional computing devices; means for determining, by the computing system and responsive to receiving the indication that the recording event has been initiated, whether each registered computing device of the set of registered computing devices is proximate to the initial computing device, wherein identifying one or more additional computing devices from the plurality of other computing devices is further based on the determining, means for determining a location of the initial computing device, means for determining a location of a candidate computing device from the plurality of other computing devices associated with the user, means for determining, based on the location of the initial computing device and the location of the candidate computing device, whether a distance between the initial computing device and the candidate computing device satisfies a distance threshold, means for responsive to determining that the distance between the initial computing device and the candidate computing device satisfies the distance threshold, identifying the candidate computing device as being one of the one or more additional computing devices, and means for determining that the one or more additional computing devices are communicatively coupled to the initial computing device via a wireless communications medium.

In another example, a computer-readable storage medium includes instructions that cause a processor to perform means for receiving, by a computing system, an indication that a recording event has been initiated on an initial computing device responsive to an input from a user, the initial computing device including an initial sensor recording first sensor data during the recording event, means for responsive to the indication of the initiation of the recording event, identifying, by the computing system and based on a respective proximity to the initial computing device of each computing device from a plurality of other computing devices associated with the user, one or more additional computing devices from the plurality of other computing devices, each computing device from the one or more additional computing devices including at least one respective sensor device, and means for transmitting, by the computing system and to the one or more additional computing devices, an activation command that causes the one or more additional computing devices to activate the at least one respective sensor device which initiates capturing of second sensor data during the recording event. In some examples, the computing system includes means for scoring, by the computing system and using a machine learning model, each computing device from the plurality of other computing devices associated with the user, means for selecting, by the computing system and based on the scoring, the one or more additional computing devices, means for outputting, by the computing system and for display by the initial computing device, information about the plurality of other computing devices associated with the user, means for receiving, by the computing system, a selection of the one or more additional computing devices from the plurality of other computing devices, means for receiving, by the computing system and from the initial computing device, an indication that the recording event has been terminated, means for responsive to receiving the indication that the recording event has been terminated, transmitting, by the computing system and to the one or more additional computing devices, a deactivation command that causes the one or more additional computing devices to deactivate the at least one respective additional sensor device which terminates the capturing of the second sensor data, means for identifying a set of registered computing devices of the user, the set of registered computing devices including the initial computing device and the one or more additional computing devices; means for determining, by the computing system and responsive to receiving the indication that the recording event has been initiated, whether each registered computing device of the set of registered computing devices is proximate to the initial computing device, wherein identifying one or more additional computing devices from the plurality of other computing devices is further based on the determining, means for determining a location of the initial computing device, means for determining a location of a candidate computing device from the plurality of other computing devices associated with the user, means for determining, based on the location of the initial computing device and the location of the candidate computing device, whether a distance between the initial computing device and the candidate computing device satisfies a distance threshold, means for responsive to determining that the distance between the initial computing device and the candidate computing device satisfies the distance threshold, identifying the candidate computing device as being one of the one or more additional computing devices, and means for determining that the one or more additional computing devices are communicatively coupled to the initial computing device via a wireless communications medium.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable medium may include computer-readable storage media or mediums, which corresponds to a tangible medium such as data storage media, or communication media including any medium that facilitates transfer of a computer program from one place to another, e.g., according to a communication protocol. In this manner, computer-readable medium generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other storage medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage mediums and media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while disks reproduce data optically with lasers. Combinations of the above should also be included within the scope of computer-readable medium.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperable hardware units, including one or more processors as described above, in conjunction with suitable software and/or firmware.

Various embodiments have been described. These and other embodiments are within the scope of the following claims.

1. A method comprising:
receiving, by a computing system, an indication that a recording event has been initiated on an initial computing device responsive to an input from a user, the initial computing device including an initial sensor recording first sensor data during the recording event;
responsive to the indication of the initiation of the recording event, identifying, by the computing system and based on a respective proximity to the initial computing device of each computing device from a plurality of other computing devices associated with the user, one or more additional computing devices from the plurality of other computing devices, each computing device from the one or more additional computing devices including at least one respective sensor device; and
transmitting, by the computing system and to the one or more additional computing devices, an activation command that causes the one or more additional computing devices to activate the at least one respective sensor device which initiates capturing of second sensor data during the recording event.

2. The method of claim 1, wherein identifying one or more additional computing devices further includes:
determining, by the computing system and using a machine learning model, a respective score for each computing device from the plurality of other computing devices associated with the user; and
selecting, by the computing system and based on the respective scores, the one or more additional computing devices.

3. The method of claim 1, wherein identifying one or more additional computing devices further includes:
outputting, by the computing system and for display by the initial computing device, information about the plurality of other computing devices associated with the user; and
receiving, by the computing system, a selection of the one or more additional computing devices from the plurality of other computing devices.

4. The method of claim 1 further comprising:
receiving, by the computing system and from the initial computing device, an indication that the recording event has been terminated; and
responsive to receiving the indication that the recording event has been terminated, transmitting, by the computing system and to the one or more additional computing devices, a deactivation command that causes the one or more additional computing devices to deactivate the at least one respective additional sensor device which terminates the capturing of second sensor data.

5. The method of claim 1, further comprising:
identifying a set of registered computing devices of the user, the set of registered computing devices including the initial computing device and the one or more additional computing devices; and
responsive to receiving the indication that the recording event has been initiated, determining, by the computing system, whether each registered computing device from the set of registered computing devices is proximate to the initial computing device,
wherein the one or more additional computing devices include each registered computing device from the set of registered computing devices determined to be proximate to the initial computing device.

6. The method of claim 1, wherein identifying the one or more additional computing devices comprises:
determining a location of the initial computing device;
determining a location of a candidate computing device from the plurality of other computing devices associated with the user;
determining, based on the location of the initial computing device and the location of the candidate computing device, whether a distance between the initial computing device and the candidate computing device satisfies a distance threshold; and
responsive to determining that the distance between the initial computing device and the candidate computing device satisfies the distance threshold, identifying the candidate computing device as being one of the one or more additional computing devices.

7. The method of claim 1, wherein identifying the one or more additional computing devices from the plurality of other computing devices comprises:
determining that the one or more additional computing devices are communicatively coupled to the initial computing device via a wireless communications medium.

8-10. (canceled)

11. A computing system comprising:
a network adapter;
a storage device that stores one or more modules; and
at least one processor that executes the one or more modules to:
receive, using the network adapter, an indication that a recording event has been initiated on an initial computing device responsive to an input from a user, the initial computing device includes an initial sensor that records first sensor data during the recording event;
responsive to the indication of the initiation of the recording event, identify, based on a respective proximity to the initial computing device of each computing device from a plurality of other computing devices associated with the user, one or more additional computing devices from the plurality of other computing devices, each computing device from the one or more additional computing devices including at least one respective sensor device; and
transmit, using the network adapter and to the one or more additional computing devices, an activation command that causes the one or more additional computing devices to activate the at least one respective sensor device which initiates capturing of second sensor data during the recording event.

12. The computing system of claim 11, further comprising:
a memory that stores a machine learning model,
wherein the at least one processor executes the one or more modules to identify the one or more additional computing devices by at least executing the one or more modules to:
determine, using the machine learning model, a respective score for each computing device from the plurality of other computing devices; and
select, based on the respective scores, the one or more additional computing devices.

13. The computing system of claim 11, wherein the at least one processor executes the one or more modules to identify the one or more additional computing devices by at least executing the one or more modules to:
output, for display by the initial computing device, information about the plurality of other computing devices associated with the user; and
receive a selection of the one or more additional computing devices from the plurality of other computing devices.

14. The computing system of claim 11, wherein the at least one processor further executes the one or more modules to:
receive, from the initial computing device, an indication that the recording event has been terminated; and
responsive to receiving the indication that recording event has been terminated, transmit, to the one or more additional computing devices, a deactivation command that causes the one or more additional computing devices to deactivate the at least one respective additional sensor device which terminates the capturing of second sensor data.

15. The computing system of claim 11, wherein the at least one processor further executes the one or more modules to:
identify a set of registered computing devices of the user, the set of registered computing devices including the initial computing device and the one or more additional computing devices; and
responsive to receiving the indication that the recording event has been initiated, determine whether each registered computing device of the set of registered computing devices is proximate to the initial computing device,
wherein the one or more additional computing devices include each registered computing device from the set of registered computing devices determined to be proximate to the initial computing device.

16. The computing system of claim 11, wherein the at least one processor executes the one or more modules to identify the one or more additional computing devices by at least executing the one or more modules to:
determine a location of the initial computing device;
determine a location of a candidate computing device from the plurality of other computing devices associated with the user;
determine, based on the location of the initial computing device and the location of the candidate computing device, whether a distance between the initial computing device and the candidate computing device satisfies a distance threshold; and
responsive to determining that the distance between the initial computing device and the candidate computing device satisfies the distance threshold, identify the candidate computing device as being one of the one or more additional computing devices.

17. The computing system of claim 11, wherein the at least one processor executes the one or more modules to identify the one or more additional computing devices by at least executing the one or more modules to:
determine that the one or more additional computing devices are communicatively coupled to the initial computing device via a wireless communications medium.

18. A non-transitory computer-readable storage medium encoded with instructions that, when executed, cause one or more processors to:
receive an indication that a recording event has been initiated on an initial computing device responsive to an input from a user, the initial computing device includes an initial sensor that records first sensor data during the recording event;
responsive to the indication of the initiation of the recording event, identify, based on a respective proximity to the initial computing device of each computing device from a plurality of other computing devices associated with the user, one or more additional computing devices from the plurality of other computing devices, each computing device from the one or more additional computing devices including at least one respective sensor device; and
transmit, to the one or more additional computing devices, an activation command that causes the one or more additional computing devices to activate the at least one respective sensor device which initiates capturing of second sensor data during the recording event.

19. The computer-readable storage medium of claim 18, wherein the instructions cause the one or more processors to identify one or more additional computing devices by at least causing the one or more processors to:
determine, using a machine learning model, a respective score for each computing device from the plurality of other computing devices; and
select, based on the respective scores, the one or more additional computing devices.

20. The computer-readable storage medium of claim 18, wherein the instructions further cause the processor to:
receive, from the initial computing device, an indication that the recording event has been terminated; and
responsive to receiving the indication that recording event has been terminated, transmit, to the one or more additional computing devices, a deactivation command that causes the one or more additional computing devices to deactivate the at least one respective additional sensor device which terminates the capturing of second sensor data.

21. The computer-readable storage medium of claim 18, wherein the instructions further cause the processor to:
identify a set of registered computing devices of the user, the set of registered computing devices including the initial computing device and the one or more additional computing devices; and
responsive to receiving the indication that the recording event has been initiated, determine whether each registered computing device of the set of registered computing devices is proximate to the initial computing device,
wherein the one or more additional computing devices include each registered computing device from the set of registered computing devices determined to be proximate to the initial computing device.

22. The computer-readable storage medium of claim 18, wherein the instructions cause the one or more processors to identify one or more additional computing devices by at least causing the one or more processors to:
determine a location of the initial computing device;
determine a location of a candidate computing device from the plurality of other computing devices associated with the user;
determine, based on the location of the initial computing device and the location of the candidate computing device, whether a distance between the initial computing device and the candidate computing device satisfies a distance threshold; and
responsive to determining that the distance between the initial computing device and the candidate computing device satisfies the distance threshold, identify the candidate computing device as being one of the one or more additional computing devices.

23. The computer-readable storage medium of claim 18, wherein the instructions cause the one or more processors to identify one or more additional computing devices by at least causing the one or more processors to:
determine that the one or more additional computing devices are communicatively coupled to the initial computing device via a wireless communications medium.
